(19) United States
(12) Patent Application Publication
(10) Pub. No.: US 2025/0046162 A1
(43) Pub. Date: Feb. 6, 2025

(54) IMMERSIVE IMAGE EXPERIENCING DEVICE

(71) Applicant: The2H Inc., Seoul (KR)

(72) Inventors: SEUNG HUN LEE, Yongin-si (KR); BO NAM LEE, Seongnam-si (KR)

(21) Appl. No.: 18/790,125

(22) Filed: Jul. 31, 2024

(30) Foreign Application Priority Data
Aug. 2, 2023 (KR) 10-2023-0100886

(51) Int. Cl. G08B 7/00; H04R 1/02

(52) U.S. Cl. CPC G08B 7/00; H04R 1/028

(57) ABSTRACT

The present disclosure related to an immersive image experiencing device comprising a main body configured to be hung around a user's neck and a sensory unit configured to be provided on one side of the main body and linked to a display for outputting a video being viewed by the user and to provide a sensory effect for each screen to the user's neck according to a sensory effect code provided for each screen of the video, thereby providing a relatively simple, lightweight, and compact wearable structure to directly transmit the sense of reality of multimedia videos, including movies, to the user's body, thereby enhancing the sense of immersion in watching a video.

### CROSS-REFERENCE TO RELATED APPLICATION(S)

This application claims priority to Korean Patent Application No. 10-2023-0100886 filed in the Korean Intellectual Property Office on Aug. 2, 2023, the disclosure of which is incorporated by reference herein in its entirety.

### TECHNICAL FIELD

The present disclosure relates to an immersive image experiencing device, and more specifically, to an immersive image experiencing device that allows a relatively simple, lightweight, and compact wearable structure to directly transmit the sense of reality of multimedia images (including videos), including movies, to the user's body, thereby enhancing the sense of immersion in watching a video.

### DISCUSSION OF RELATED ART

In recent years, in order to make movie viewing more interesting, three-dimensional (3D) movies, which are a departure from two-dimensional (2D) movies displayed on a flat screen, and even four-dimensional (4D) movie theaters, which allow viewers to experience various special effects corresponding to various events in the plot of the movie, have appeared.

For example, the “4D movie theater system” of KR Registered Patent No. 10-216361 (hereinafter referred to as “Prior Art 1”) was invented from the above perspective.

However, conventional 4D movie theaters, including theaters disclosed by Prior Art 1, have a problem that they are not easily accessible to a large number of visitors.

In other words, 4D theaters are costly and time-consuming to initially install and construct, and with the recent launch of many over-the-top (OTT) services such as Netflix, YouTube, or Disney+, the number of visitors to theaters has been dispersed.

Therefore, with the promotion of such OTT services, existing theater franchises are burdened with the construction and construction of additional 4D theaters.

As inventions made from the above viewpoint, examples thereof include “Special effects 4D helmet for movies and video games” of KR Patent Laid-open No. 10-2011-0093683 (hereinafter referred to as “Prior Art 2”).

Prior Art 2 combines various effects such as water, light, wind, vibration, etc. to create a variety of special effects that can be experienced at home.

However, Prior Art 2 is provided in a form in which the headphones, the blower device and the lamp device connected to the headphones, are worn in close contact with the user's back of the head and crown of the head to the upper forehead due to its structural characteristics so that users who are interested in hairstyles and beauty face the problem that the hair is pressed down and interferes with the hairstyle.

In particular, the Prior Art 2 is equipped with a fan for performing a blowing function or a tank for receiving water for operating a water effect device, etc., which places a significant load on the user's head, causing strain on the user's neck and joints during prolonged viewing.

Moreover, the Prior Art 2 may be considered unpleasant by some users for special effects such as water jets caused by the operation of the water effect device.

### SUMMARY

The present disclosure is to provide an immersive image experiencing device, and more specifically, to an immersive image experiencing device that allows a relatively simple, lightweight, and compact wearable structure to directly transmit the sense of reality of multimedia videos, including movies, to the user's body, thereby enhancing the sense of immersion in watching a video.

Further, the present disclosure is to provide an immersive image experiencing device that allows the user to easily enjoy the effects of watching a 4D movie theater at home, while completely eliminating any special effects that cause discomfort and allowing the user to enjoy watching a movie with a more vivid sense of reality and immersion.

The present disclosure may provide an immersive image experiencing device comprising a main body configured to be hung around a user's neck and a sensory unit configured to be provided on one side of the main body and linked to a display for outputting a video being viewed by the user and to provide a sensory effect for each screen to the user's neck according to a sensory effect code provided for each screen of the video.

The main body may comprise a rear holder including an inner side facing a back of the user's neck and a side holder extending from both left and right sides of the rear holder and including an inner side facing left and right sides of the user's neck.

The sensory unit may comprise a coolness and warmth providing unit provided on one side of the main body to provide coolness and warmth to the user's neck, an air supply unit provided on one side of the main body to blow wind toward the user, and a touch providing unit provided on one side of the main body to create a tactile sensation on the user's neck.

The sensory unit may comprise a shock vibration providing unit provided on one side of the main body to provide vibration to the user and a bone conduction vibration sensory providing unit provided on one side of the main body to transmit sound and voice through the user's back in a bone conduction manner.

The air supply unit may further comprise a plurality of first discharge holes through which air is discharged toward the back of the user's neck, and a plurality of second discharge holes through which air is discharged toward the left and right sides of the user's neck.

The device may further comprise a conductive pad provided on one side of the main body and capable of contacting both left and right sides of the user's neck, and providing a feeling of coolness and warmth to the user.

The device may further comprise a vibration pad electrically connected to the main body and be in contact with the user's back, and transmitting sound and voice through the user's back in a bone conduction manner.

The coolness and warmth providing unit may comprise a conductive pad formed on each side holder connected to each side of the rear holder of the main body and contacting both left and right sides of the user's neck, a cooling and heating means built into the main body and electrically connected to the conductive pad and heating or cooling the conductive pad, and a cooling and heating controller built into the main body and electrically connected to the cooling and heating means and heating or cooling the cooling and heating means.

The air supply unit may comprise an air generating means built into the main body to discharge air toward the user's neck, a plurality of first discharge holes penetrating the rear holder of the main body to discharge air generated from the air generating means toward the back of the user's neck, and a plurality of second discharge holes penetrating the side holders connected to both sides of the rear holder to discharge air generated from the air generating means toward the left and right sides of the user's neck.

The touch providing unit may comprise an installation slot formed by cutting into the rear holder of the main body facing the back of the user's neck and a contact piece having a surface exposed through the installation slot, contacting the back of the user's neck to provide a sense of touch, and made of one or a combination of at least one of fiber, synthetic fiber, resin, and synthetic resin, and the contact piece may be moved to provide the sense of touch to the user's neck.

The shock vibration providing unit may comprise a vibration generating means built into the main body to receive driving force and provide vibration to the user.

The bone conduction vibration sensory providing unit may comprise a cable extending from one side of the main body, a vibration pad connected to a distal end of the cable and provided so as to be in contact with the back of the user, and transmitting sound and voice through the user's back in a bone conduction manner, and a vibration controller built into the main body and electrically connected to a proximal end of the cable to operate the vibration pad.

The device may further include a goosebump-inducing mode that provides a cool sensation to the user by the coolness and warmth providing unit along with the operation of the touch providing unit and allows goosebumps on the skin of the user who is watching the video by blowing wind toward the user by the air supply unit.

The device may further includes a climate sensation mode that allows the user who is watching the video to experience the atmosphere and climate in the video by blowing wind toward the user by the air supply unit along with the operation of the coolness and warmth providing unit.

The device may further comprise a sensory effect code processing unit configured to be capable of communicating with or electrically connecting to the sensory unit and generates and stores a reality connected cinema (RCC) code, which is a sensory effect code that causes a plurality of different sensory effects to be transmitted to the user's body by the sensory unit to appear and disappear for a predetermined period of time at a required playback point on a screen in a video to be watched by the user, and synchronize the RCC code with the screen in the video to be watched by the user.

According to the present disclosure having the above configuration, the following effects can be achieved.

First of all, the present disclosure may provide a relatively simple, lightweight, and compact wearable structure to directly transmit the sense of reality of multimedia videos, including movies, to the user's body, thereby enhancing the sense of immersion in watching a video.

Further, the present disclosure may allow the user to easily enjoy the effects of watching a 4D movie theater at home, while completely eliminating any special effects that cause discomfort and allowing the user to enjoy watching a movie with a more vivid sense of reality and immersion.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a conceptual view illustrating a user wearing an immersive image experiencing device according to one embodiment of the present disclosure watching a video;

FIG. 2 is a perspective conceptual view illustrating a user wearing an immersive image experiencing device according to another embodiment of the present disclosure and the overall appearance of the device;

FIG. 3 is a front conceptual view illustrating the overall appearance of an immersive image experiencing device according to another embodiment of the present disclosure;

FIG. 4 is a side conceptual view illustrating a user wearing an immersive image experiencing device according to another embodiment of the present disclosure;

FIG. 5 is a conceptual view illustrating a network communication relationship and an operational relationship between a sensory unit and a sensory effect code processing unit, which are main parts of an immersive image experiencing device according to another embodiment of the present disclosure; and

FIG. 6 is a conceptual view illustrating a program main window showing a state in which the sensory unit and the video are synchronized by the sensory effect code processing unit, which is a main part of an immersive image experiencing device according to another embodiment of the present disclosure.

### DETAILED DESCRIPTION OF EXEMPLARY EMBODIMENTS

Advantages and characteristics of the present disclosure, and methods for achieving them become clear with reference to the embodiments described later in detail in conjunction with the drawings.

However, the present disclosure is not limited to the embodiments disclosed below and is implemented in various different forms.

In this specification, this embodiment is provided to complete the present disclosure, and to completely inform those skilled in the art of the scope of the present disclosure to which the present disclosure belongs.

Further, the present disclosure is only defined by the scope of the claims.

Thus, in some embodiments, well-known components, well-known operations and well-known techniques have not been described in detail in order to avoid obscuring the interpretation of the present disclosure.

Further, like reference numerals designate like elements throughout the specification, and terms used (referred to) in this specification are for describing embodiments and are not intended to limit the present disclosure.

In this specification, the singular also includes the plural unless specifically stated in the phrase, and components and operations referred to as ‘comprising (or including)’ do not exclude the presence or addition of one or more other components and operations.

Unless otherwise defined, all terms (including technical and scientific terms) used in this specification may be used in a meaning commonly understood by those of ordinary skill in the art to which the present disclosure belongs.

In addition, terms defined in commonly used dictionaries are not interpreted ideally or excessively unless they are defined.

Hereinafter, preferred embodiments of the present disclosure are described with reference to the accompanying drawings.

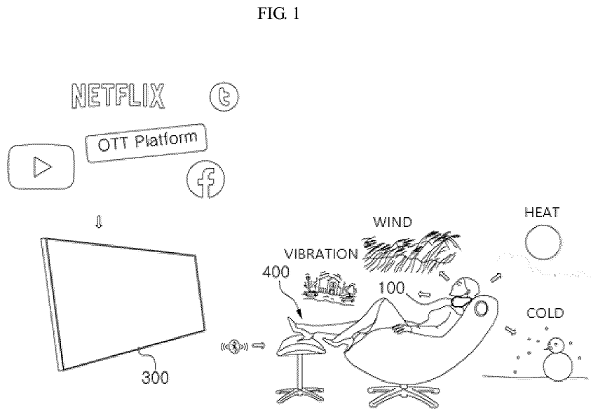

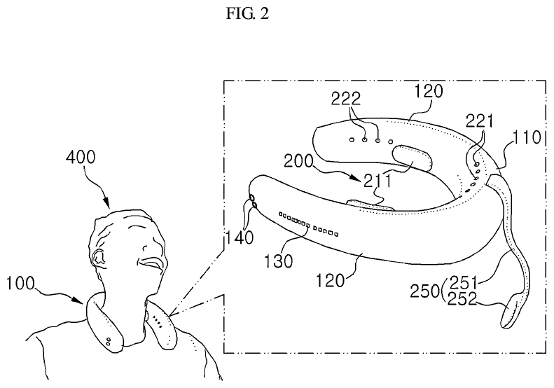

FIG. 1 is a conceptual view illustrating a user 400 wearing an immersive image experiencing device according to one embodiment of the present disclosure watching a video. FIG. 2 is a perspective conceptual view illustrating a user 400 wearing an immersive image experiencing device according to another embodiment of the present disclosure and the overall appearance of the device.

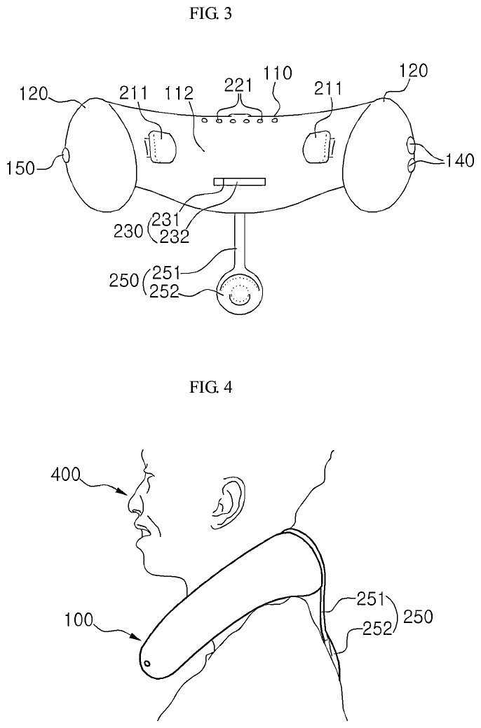

FIG. 3 is a front conceptual view illustrating the overall appearance of an immersive image experiencing device according to another embodiment of the present disclosure.

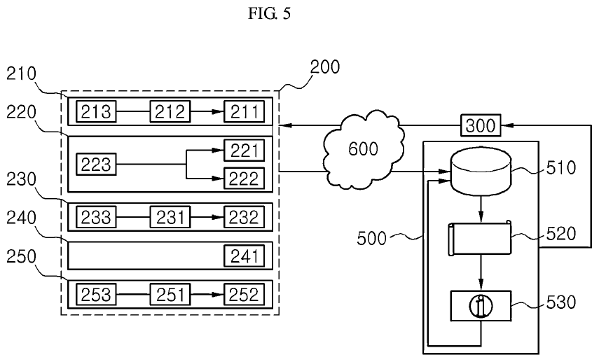

FIG. 4 is a side conceptual view illustrating a user 400 wearing an immersive image experiencing device according to another embodiment of the present disclosure.

FIG. 5 is a conceptual view illustrating a network 600 communication relationship and an operational relationship between a sensory unit 200 and a sensory effect code processing unit 500, which are main parts of an immersive image experiencing device according to another embodiment of the present disclosure.

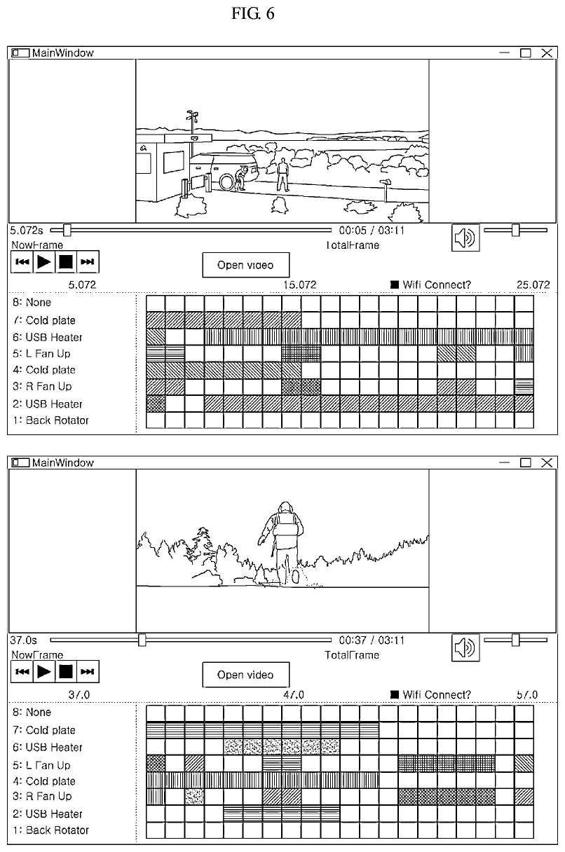

FIG. 6 is a conceptual view illustrating a program main window showing a state in which the sensory unit 200 and the video are synchronized by the sensory effect code processing unit 500, which is a main part of an immersive image experiencing device according to another embodiment of the present disclosure.

As shown in FIGS. 1 to 4, an embodiment including a main body 100 configured to be hung around a neck of a user 400, and a sensory unit 200 configured to be provided on one side of the main body 100 and linked to a display 300 for outputting a video being viewed by the user 400 may be applied.

The sensory unit 200 may play a role in further enhancing the vividness and immersion of watching a movie by providing sensory effects corresponding to the screens to the neck area of the user 400, more specifically, to the phrenic nerve and cervical vertebrae around the neck, according to the sensory effect code provided for each screen of the video as shown in FIG. 1.

The sensory effects may be various special effects that the user 400 can feel, including, for example, heat, wind, cold, and vibration.

The term “video” used in the present disclosure is defined to include anything that a user 400 can visually perceive and appreciate through a screen, for example a medium such as a movie or drama that is made up of multiple screens and can be enjoyed by a user 400, or a medium such as a video game.

The above embodiments of the structure can be applied to the present disclosure, and the following various embodiments can also be applied thereto.

First, the main body 100 may include the rear holder 110 having an inner side facing the first to seventh cervical vertebrae of the user 400 and the side holder 120 extending from the left and right sides of the rear holder 110 and having an inner side facing the nape of the neck of the user 400 and a lower edge facing the collarbone.

Here, it can be seen that the sensory unit 200 to be described later is placed on the rear holder 110 and the side holder 120.

Meanwhile, the sensory unit 200 may generally include the coolness and warmth providing unit 210, the air supply unit 220, the touch providing unit 230, the shock vibration providing unit 240, and the bone conduction vibration sensory providing unit 250, as shown in FIG. 5.

The coolness and warmth providing unit 210 may be provided on one side of the main body 100 to provide coolness and warmth to the neck of the user 400.

That is, the coolness and warmth providing unit 210 may be positioned at the location where the phrenic nerve passes through the nape of the neck of the user 400 to perform an action of increasing the temperature by a certain amount compared to the body temperature of the user 400 on the screen in the video.

The user 400 may feel a sense of warmth as the coolness and warmth providing unit 210 operates and become immersed in the screen of the video being watched.

The air supply unit 220 may be provided on one side of the main body 100 to blow air toward the user 400.

That is, the air supply unit 220 may be positioned at a location where the phrenic nerve of the user 400 passes and facing the cheek and earlobe of the user 400 to perform an operation of blowing air while decreasing the temperature by a certain amount compared to the body temperature of the user 400 on the screen in the video.

The touch providing unit 230 may be provided on one side of the main body 100 to provide a tactile sensation to the neck of the user 400.

That is, the touch providing unit 230 may directly contact the neck of the user 400 to provide a tactile sensation similar to a snake or insect crawling.

The shock vibration providing unit 240 may be provided on one side of the main body 100 to provide vibration to the user 400.

That is, the shock vibration providing unit 240 may be positioned facing the 7th cervical vertebra of the user's cervical vertebrae to provide vibration to the 7th cervical vertebrae at a certain range of frequencies so that the user 400 may feel the degree of shock occurrence, including explosions and rising, falling, or crashing on the screen in the video.

The bone conduction vibration sensation providing unit 250 may be provided on one side of the main body 100 to transmit sound and voice through the neck of the user 400 in a bone conduction manner.

That is, the bone conduction vibration sensation providing unit 250 may be positioned at a position facing the 4th to 7th cervical vertebrae and the back of the user 400 to perform the role of transmitting vibrations generated from on-screen voices, sounds, and music in the video through the 4th to 7th cervical vertebrae and the spine of the user 400 in a bone conduction manner.

The main body 100 may further include a speaker 130 that is placed between the rear holder 110 and the side holder 120 and operates in conjunction with the sensory unit 200 to output voice, sound, and music in accordance with the screen in the video.

Here, the speaker 130 may be modified and applied in a design that may be excluded in some cases.

Meanwhile, the reason why most of the parts constituting the sensory unit 200 according to the present disclosure are placed around the neck of the user 400 is because the skin on the human neck is very sensitive to touch stimulation.

This is also because the neck has a thinner skin layer and is richly distributed with nerve endings compared to other parts of the body.

The human neck may be a very sensitive area of the body, containing many nerve endings that respond to touch, pressure, temperature changes, and other stimuli.

These nerve endings in the neck may send signals to the brain that help regulate various body functions, including blood pressure, heart rate, and breathing.

In addition, the neck may be a key area for transmitting physical and emotional sensations such as pleasure, pain, and tension, the sensitivity of the skin on the neck may help protect the body and respond to stimuli, and the neck may be also an area that plays an important role in the emotional and social life of humans, so most of the sensory units 200 are designed to face the area around the nape of the neck of the user 400.

Meanwhile, the phrenic nerve may run along the side of the neck and be responsible for carrying sensory information from the skin of the neck and upper chest.

These phrenic nerves may contain specialized sensory receptors known as thermoreceptors that detect changes in temperature.

The exact location where a person is most sensitive to changes in temperature can vary from person to person, but generally, the skin along the path of the phrenic nerve is sensitive to changes in temperature.

This sensitivity may help regulate body temperature and maintain homeostasis by sending signals to the brain about changes in the environment, such as the presence of warm or cold objects.

The brain then uses this information to adjust bodily functions, such as blood flow, to maintain a stable internal environment.

Therefore, the reason why the conductive pad 211 to be described later and the first and second discharge holes 221, 222 to be described later are arranged in a position facing the phrenic nerve is to utilize this characteristic of the phrenic nerve.

Meanwhile, the main body 100 may further include an intensity control button 140 formed on one of the side holders 120 on both sides to control the operating intensity of the sensory unit 200.

The main body 100 may further include an operation button 150 formed on the other of the side holders 120 on both sides to pause or stop playback of a video being viewed by the user 400 or to turn on and off the power of the sensory unit 200 and the display 300 for video playback.

Meanwhile, the back holder 110 may further include a contact side 112 that forms an inner surface and corresponds to the distal end arrangement shape of each of the first and second cervical vertebrae of the user 400 and the nape shape of the user 400.

Here, the first discharge hole 221 of the air supply unit 220 and the installation slot 231 of the touch providing unit 230 may be formed on the contact side 112.

With reference to FIG. 5, each component of the sensory unit 200 is described in more detail.

First, the coolness and warmth providing unit 210 may be formed on each side holder 120 connected to each side of the rear holder 110 of the main body 100 and may include the conductive pad 211 that comes into contact with the left and right sides of the neck of the user 400.

The coolness and warmth providing unit 210 may include the cooling and heating means 212 built into the main body 100 and electrically connected to the conductive pad 211 to heat or cool the conductive pad 211.

Here, the cooling and heating means 212 may be used by adopting a Peltier element that utilizes the Peltier effect, i.e., a thermoelectric element.

The Peltier effect refers to the phenomenon in which a temperature difference persists at both ends of multiple layers of a conductive material due to heat absorption and heat generation in addition to the Joule heat generated by the current when current is passed through a thermocouple.

The coolness and warmth providing unit 210 may include the cooling and heating controller 213 built into the main body 100 and electrically connected to the cooling and heating means 212 to cooling the conductive pad 211.

Meanwhile, the air supply unit 220 may include the air generating means 223 built into the main body 100 to discharge air toward the neck of the user 400.

Here, the air generating means 223 may be a publicly known product that is built with an impeller having a structure that draws in air from one side and discharges the drawn air from the other side, and here, for convenience, a detailed description of the structure and operating mechanism is omitted.

The air supply unit 220 may include a plurality of first discharge holes 221 that penetrate the rear holder 110 of the main body 100 and allow air generated from the air generating means 223 to be discharged toward the back of the neck of the user 400.

The air supply unit 220 may include a plurality of second discharge holes 222 that penetrate the side holders 120 connected to both sides of the rear holder 110 and allow air generated from the air generating means 223 to be discharged toward the left and right sides of the neck of the user 400.

Here, the triggers and mechanisms of goosebumps that appear on the skin of the user 400 watching a video are as follows.

Goosebumps are caused by the contraction of small muscles at the base of the hair follicle and can be triggered by a variety of stimuli, such as strong emotions (fear, awe, excitement, etc.), cold temperatures, and some forms of music.

This physical response is believed to have evolved as a way to make the body appear larger and more threatening to potential threats, or as a way to trap insulating layers of air to keep warm.

There are many different ways to trigger goosebumps, including some of the following situations.

First, goosebumps can be triggered by listening to music that evokes strong emotions, such as moving classical music or powerful ballads.

Further, goosebumps can be triggered by recalling an emotionally impactful personal experience, such as a moment of great joy, sadness, or fear.

Moreover, goosebumps can be triggered by watching a heartbreaking movie or reading a book that evokes powerful emotions.

Furthermore, goosebumps can be triggered by exposure to cold temperatures.

Reactions to these stimuli can vary from person to person, so what works for one person may not work for another.

However, there is no organ that is particularly goosebump-inducing around the neck.

However, there are several sensitive structures in the neck that can contribute to heightened sensation, including:

The neck has a thin layer of skin that is very sensitive to touch, and the human neck is sensitive to temperature changes and other stimuli.

In addition, the neck is rich in nerve endings, including the trigeminal nerve and spinal nerve, which are responsible for the sensation of the face and head. Accordingly, the air supply unit 220 may cooperate with the coolness and warmth providing unit 210 and the touch providing unit 230, use the characteristics of the nerve endings and phrenic nerve, and operate in accordance with the screen in the video corresponding to various goosebump-inducing factors, thereby causing the user 400 to get goosebumps.

The touch providing unit 230 may include the installation slot 231 formed by cutting the rear holder 110 of the main body 100 facing the back of the neck of the user 400.

The touch providing unit 230 may include a contact piece 232 having a surface exposed through the installation slot 231, contacting the back of the neck of the user 400 to provide a sense of touch, and made of one or a combination of at least one of fiber, synthetic fiber, resin, and synthetic resin.

The touch providing unit 230 may include a touch stimulation providing means 233 built into the main body 100 and connected to the contact piece 232 and providing a tactile sensation to the neck of the user 400 by moving the contact piece 232.

Here, the touch stimulation providing means 233 is not specifically shown, but the contact piece 232 may be wound around a conventional DC motor drive shaft to adjust the rpm of the driving shaft so that it rotates very slowly.

At this time, the rpm of the driving shaft may be adjusted by an electric signal through code programming, and of course, the rpm may be adjusted by controlling the resistance value.

Further, the contact piece 232 may be prepared with various different materials and selectively detachably connected to the driving shaft to provide a touch stimulus so that various sensations may be felt depending on the nature of the video output through the display 300.

The part of the neck that feels coolest when the wind blows can vary from person to person and depend on many factors, including hair length, skin thickness, and body temperature.

However, in general, the back of the neck or nape of the neck is often considered the coolest part of the neck because it is less exposed to the sun and less insulated from clothing.

The cold sensation caused by wind blowing on the skin can be attributed to the evaporation of sweat from the skin, which lowers the skin temperature and creates a cool sensation.

The sensitivity of the skin on the back of the neck varies from person to person and can depend on many factors such as skin type, age, and past experiences.

However, the skin on the nape of the neck, which is the area at the base of the skull just above the neck, is generally considered to be one of the most sensitive areas of the body.

This is due to the concentration of nerve endings in this area, which can make it more sensitive to touch and other stimuli.

It's important to note that an individual's sensitivity to touch can vary greatly and can be affected by a variety of factors, such as anxiety, stress, or health conditions.

Also, some people may have a higher or lower sensitivity to touching certain areas of the neck due to their anatomy or past experiences.

Accordingly, one of the air generating means 223 used in the air supply unit 220 may be a brushless DC (BLDC) motor, enabling detailed intensity control in multiple stages.

Meanwhile, the shock vibration providing unit 240 may include a vibration generating means 241 built into the main body 100 and receiving driving force to provide vibration to the user 400.

That is, the vibration generating means 241 is built into the connection part of the side holder 120 connected to both sides of the rear holder 110 of the main body 100 or any point of the rear holder 110 corresponding to the 7th cervical vertebra and may receive driving force to transmit vibration to the body of the user 400.

Here, the vibration generating means 241 may adopt the structure of a general vibrator that generates vibration by mounting an eccentric weight (not shown) on a known DC motor drive shaft and rotating it.

At this time, the vibration generating means 241 may be provided on the left and right sides inside the main body 100 depending on the case, so that the left and right sides operate simultaneously or individually, thereby enabling the user 400 who is watching a video or enjoying a game while watching a video to detect movement in a specific direction such as up and down or left and right when walking, flying, or swimming in the current video.

The most protruding bone in a person's neck is the 7th cervical vertebra, commonly referred to as the “C7” vertebra.

The C7 vertebra, located at the base of the neck and often referred to as the “Adam's apple” in men, is the most prominent vertebra and plays an important role in the structure and stability of the neck as well as the movement and flexibility of the head and neck.

The C7 vertebra acts as an attachment point for several muscles, ligaments, and tendons that support the head and neck and allow for a wide range of motion.

The protrusion of the C7 vertebra in the neck can be a useful landmark for anatomical and medical purposes, such as determining the location of the spinal cord and performing certain medical procedures.

The C7 vertebra is part of a flexible and mobile part of the spine that allows for a wide range of motion of the head and neck.

This mobility is critical for activities such as turning head, looking up and down, and tilting head to the side.

The C7 vertebrae are connected to the other bones and muscles of the neck by various ligaments, tendons, and muscles, which work together to provide stability and support to the neck.

This stability helps prevent injuries and maintain proper posture.

The C7 vertebra in the neck is a useful landmark for medical and anatomical purposes.

For example, it can be used as a reference point for certain medical procedures, such as injections or spinal taps, or it can be used to identify the location of other structures in the neck, such as the vertebrae.

Overall, the C7 vertebra plays an important role in the anatomy and function of the neck, contributing to mobility, stability, and structural support.

Meanwhile, the bone conduction vibration sensation providing unit 250 may include a cable 251 extending from one side of the main body 100.

The bone conduction vibration sensation providing unit 250 may include a vibration pad 252 connected to the distal end of the cable 251 to be in contact with the back of the user 400, transmitting sound and voice through the back of the user 400 in a bone conduction manner.

The bone conduction vibration sensation providing unit 250 may include a vibration controller 253 built into the main body 100, electrically connected to the proximal end of the cable 251 to operate the vibration pad 252.

The vibration controller 253 may be electrically connected to the vibration pad 251 and operate the vibration pad 252 during the time that the vibration pad 252 on the screen in the video should operate according to preset data and setting values and then stop it.

Here, the vibration pad 252 is not a complex separate component for providing vibration, but can be a vibration speaker with a built-in vibration plate (not shown) that causes vibration according to the waveform of music or sound in the video.

A typical bone conduction earphone is designed to transmit sound through the bones of the skull, bypassing the traditional air-based sound transmission pathway.

The sound from the earphones is transmitted to the inner ear through vibrations in the bones of the skull, specifically the temporal bone.

This bone is located just in front of the ear, near the temple, and is close to the cochlea and inner ear.

The vibrations from bone-conduction earphones reach the inner ear through the bones of the skull, without passing the eardrum, outer and middle ear.

This method of sound delivery can be especially beneficial for individuals with certain hearing conditions.

Like conductive hearing loss, it affects the ability of sound to reach the inner ear through the traditional air-based pathway.

By bypassing the damaged part of the ear, bone conduction earphones can provide an effective way for these individuals to hear sound.

Meanwhile, the sensory unit 200 may implement a goosebump-inducing mode by providing a cold sensation to the user 400 by the coolness and warmth providing unit 210 and blowing air towards the user 400 by the air supply 220 in conjunction with the operation of the touch providing 230, thereby causing goosebumps on the skin of the user 400 watching the video.

In such a goosebumps-inducing mode, the coolness and warmth providing unit 210 may provide a cold sensation to the user 400 at 1 to 5 degrees Celsius lower than the body temperature of the user 400.

More preferably, the cooling and heating means 213 may be operated at a temperature about 3 degrees Celsius lower than the body temperature of the user 400.

The sensory unit 200 may implement a climate sensation mode that allows a user 400 watching a video to experience the atmosphere and climate in the video by blowing wind toward the user 400 through the air supply unit 220 together with the operation of the coolness and warmth providing unit 210.

In this climate sensation mode, the coolness and warmth providing unit 210 may provide a cool or warm sensation to the user 400 at 5 degrees Celsius lower or 2 degrees Celsius higher than the body temperature of the user 400, while the air supply unit 220 may discharge wind at a wind speed of 0.3 to 5.4 m/s toward the user 400.

In other words, for implementing the climate experience mode, the user 400 may maximize the effect of climate change on the user 400 by appropriately regulating the temperature, preferably in a range of 3 degrees Celsius or less and 1 degree Celsius or more relative to the body temperature.

Human skin is generally safe within a temperature range of 32-40 degrees Celsius.

However, skin temperature can vary depending on factors such as time of day, physical activity, and ambient temperature.

Due to differences in nerve endings, blood supply, and skin thickness, skin on different parts of the body can have different temperature sensitivities.

Neck skin is often considered to be more temperature sensitive than other parts of the body due to the abundance of nerve endings in the neck area.

This increased sensitivity allows the neck skin to detect even small changes in temperature and transmit this information to the brain.

Meanwhile, the frequency band according to the operation of the vibration generating means 241 is preferably 20 to 50 Hz.

Here, vibrations below 20 Hz are too weak to be perceived by the user 400, and vibrations above 50 Hz are strong enough to cause discomfort or pain to the user 400. Therefore, vibrations in the appropriate frequency range should be generated.

The frequency range of 20 to 50 Hz is best suited to transmit vibrations to the bone.

This is because these frequency bands have been found to be most effective in transmitting vibrations through the bones to the inner ear, where they can be perceived as sound.

Therefore, bone conduction headphones and hearing aids often use this frequency range to provide clear sound for people with hearing loss.

Meanwhile, the pressure applied to the back of the user 400 by the vibration pad 252 and the pressure applied to the body of the user 400 by the operation of the motion sickness reduction providing unit 260 may be 5 to 15 psi.

Here, pressure below 5 psi is too weak to be perceived by the user 400, and pressure exceeding 15 psi causes discomfort or pain to the user 400, or even injury, so vibration is generated within an appropriate pressure range.

More preferably, vibration is generated or pressure is applied at a pressure of about 10 psi.

The vibration pad 252 may be made of a material such as austenitic stainless steel 304 and 316, which has strength and the ability to withstand high stress.

This type of stainless steel contains high levels of chromium and nickel, giving it excellent strength and corrosion resistance.

Materials such as these stainless steels 304 and 316 are generally considered strong and durable materials suitable for use in headbands.

Meanwhile, the present disclosure may further include a sensory effect code processing unit 500 that is communicative or electrically connected to the sensory unit 200 as shown in FIG. 6.

The sensory effect code processing unit 500 may perform a process to synchronize a plurality of different sensory effects, including heat, cold, vibration, wind, and bone conduction vibration, to be transmitted to the body of the user 400 by the sensory unit 200, with events on the screen in the video to be viewed by the user 400.

That is, the sensory effect code processing unit 500 generates and stores the sensory effect code, reality connected cinema (RCC) code, which causes various events generated by the sensory unit 200 to occur for a certain period of time at a required playback point on the screen of a video to be viewed by the user 400 and then disappear, thereby performing a process of synchronizing the sensory effect code with events in the plot of the video to be viewed by the user 400.

FIG. 8 shows a screen shot of a software program that performs the process of synchronizing the sense effect code to the video.

This sensory effect code processing unit 500 may further include a database 510 that stores data obtained by comparing and analyzing the sensory response of the user 400 according to the operation of the sensory unit 200 with the real-time body temperature and heart rate of the user 400 and assigning grades.

Further, the sensory effect code processing unit 500 may further include a code generation unit 520 generating different RCC codes by combining multiple data stored in the database 510 with the genre of the video or other video viewed by the user 400 and other users 400 and the part of the storyline of the video and other videos where the sensory unit 200 should be operated.

The sensory effect code processing unit 500 may further include an AI analysis unit 530 matching, based on comparative analysis of multiple data and multiple generated RCC codes, a temperature change, a goosebump-inducing event, a climate change detection event, a shock vibration generation event according to the degree of shock occurrence, or a bone conduction vibration generation event that transmits vibrations generated from voices, sounds, and music of the corresponding video and another video through bone conduction, which are necessary on the screen of the corresponding video and another video.

Accordingly, when a large amount of data collected by the AI analysis unit 530 as shown in FIGS. 5 and 6 is stored in the database 510, the RCC code generated by the code generation unit 520 is synchronized to a specific time line of the video for a precisely set time, and the operation of the sensory unit 200 is performed according to the synchronized RCC code, so that the user 400 may enjoy watching a more immersive video.

The present disclosure is to provide an immersive image experiencing device, and more specifically, to an immersive image experiencing device that allows a relatively simple, lightweight, and compact wearable structure to directly transmit the sense of reality of multimedia videos, including movies, to the user's body, thereby enhancing the sense of immersion in watching a video.

Within the scope of the basic technical idea of the present disclosure, many other modifications and applications can be made by those skilled in the art.

What is claimed is:

1. A immersive image experiencing device comprising:
a main body configured to be hung around a user's neck; and
a sensory unit configured to be provided on one side of the main body and linked to a display for outputting a video being viewed by the user and to provide a sensory effect for each screen to the user's neck according to a sensory effect code provided for each screen of the video.

2. The immersive image experiencing device of claim 1,
wherein the main body comprises a rear holder including an inner side facing a back of the user's neck; and
a side holder extending from both left and right sides of the rear holder and including an inner side facing left and right sides of the user's neck.

3. The immersive image experiencing device of claim 1,
wherein the sensory unit comprises a coolness and warmth providing unit provided on one side of the main body to provide coolness and warmth to the user's neck;
an air supply unit provided on one side of the main body to blow wind toward the user; and
a touch providing unit provided on one side of the main body to create a tactile sensation on the user's neck.

4. The immersive image experiencing device of claim 1,
wherein the sensory unit comprises a shock vibration providing unit provided on one side of the main body to provide vibration to the user; and
a bone conduction vibration sensory providing unit provided on one side of the main body to transmit sound and voice through the user's back in a bone conduction manner.

5. The immersive image experiencing device of claim 1,
wherein the air supply unit further comprises a plurality of first discharge holes through which air is discharged toward the back of the user's neck, and
a plurality of second discharge holes through which air is discharged toward the left and right sides of the user's neck.

6. The immersive image experiencing device of claim 1, further comprising a conductive pad provided on one side of the main body and capable of contacting both left and right sides of the user's neck, and providing a feeling of coolness and warmth to the user.

7. The immersive image experiencing device of claim 1, further comprising a vibration pad electrically connected to the main body and be in contact with the user's back, and transmitting sound and voice through the user's back in a bone conduction manner.

8. The immersive image experiencing device of claim 3,
wherein the coolness and warmth providing unit comprises a conductive pad formed on each side holder connected to each side of the rear holder of the main body and contacting both left and right sides of the user's neck;
a cooling and heating means built into the main body and electrically connected to the conductive pad and heating or cooling the conductive pad; and
a cooling and heating controller built into the main body and electrically connected to the cooling and heating means and heating or cooling the cooling and heating means.

9. The immersive image experiencing device of claim 3,
wherein the air supply unit comprises an air generating means built into the main body to discharge air toward the user's neck;
a plurality of first discharge holes penetrating the rear holder of the main body to discharge air generated from the air generating means toward the back of the user's neck; and
a plurality of second discharge holes penetrating the side holders connected to both sides of the rear holder to discharge air generated from the air generating means toward the left and right sides of the user's neck.

10. The immersive image experiencing device of claim 3,
wherein the touch providing unit comprises an installation slot formed by cutting into the rear holder of the main body facing the back of the user's neck; and
a contact piece having a surface exposed through the installation slot, contacting the back of the user's neck to provide a sense of touch, and made of one or a combination of at least one of fiber, synthetic fiber, resin, and synthetic resin, and
wherein the contact piece is moved to provide the sense of touch to the user's neck.

11. The immersive image experiencing device of claim 4,
wherein the shock vibration providing unit comprises a vibration generating means built into the main body to receive driving force and provide vibration to the user.

12. The immersive image experiencing device of claim 4,
wherein the bone conduction vibration sensory providing unit comprises a cable extending from one side of the main body;
a vibration pad connected to a distal end of the cable and provided so as to be in contact with the back of the user, and transmitting sound and voice through the user's back in a bone conduction manner; and
a vibration controller built into the main body and electrically connected to a proximal end of the cable to operate the vibration pad.

13. The immersive image experiencing device of claim 3, further including a goosebump-inducing mode that provides a cool sensation to the user by the coolness and warmth providing unit along with the operation of the touch providing unit and allows goosebumps on the skin of the user who is watching the video by blowing wind toward the user by the air supply unit.

14. The immersive image experiencing device of claim 3, further including a climate sensation mode that allows the user who is watching the video to experience the atmosphere and climate in the video by blowing wind toward the user by the air supply unit along with the operation of the coolness and warmth providing unit.

15. The immersive image experiencing device of claim 1, further comprising a sensory effect code processing unit configured to be capable of communicating with or electrically connecting to the sensory unit and generates and stores a reality connected cinema (RCC) code, which is a sensory effect code that causes a plurality of different sensory effects to be transmitted to the user's body by the sensory unit to appear and disappear for a predetermined period of time at a required playback point on a screen in a video to be watched by the user, and synchronize the RCC code with the screen in the video to be watched by the user.
